(19) United States
(12) Patent Application Publication
(10) Pub. No.: US 2019/0370714 A1
(43) Pub. Date: Dec. 5, 2019

(54) TECHNIQUES FOR BEHAVIORAL PAIRING IN A TASK ASSIGNMENT SYSTEM

(71) Applicant: Afiniti Europe Technologies Limited, Cheshire (GB)

(72) Inventor: Denys LIUBYVYI, Washington, DC (US)

(73) Assignee: Afiniti Europe Technologies Limited, Cheshire (GB)

(21) Appl. No.: 15/993,496

(22) Filed: May 30, 2018

(51) Int. Cl. G06Q 10/06

(52) U.S. Cl. CPC G06Q 10/06316; G06Q 10/0633

(57) ABSTRACT

Techniques for behavioral pairing in a task assignment system are disclosed. In one particular embodiment, the techniques may be realized as a method for behavioral pairing in a task assignment system comprising: determining, by at least one computer processor communicatively coupled to and configured to operate in the task assignment system, an expected loss of each of a plurality of tasks; determining, by the at least one computer processor, an agent available for assignment to any of the plurality of tasks; and assigning, by the at least one computer processor, a task of the plurality of tasks to the agent using a task assignment strategy based on the expected loss of the task.

### CROSS-REFERENCE TO RELATED APPLICATIONS

This patent application is related to U.S. patent application Ser. No. 15/837,911, filed Dec. 11, 2017, and co-pending U.S. patent application No. [matter 2211471.00450US1], filed May 30, 2018, which are hereby incorporated by reference herein in their entirety.

### FIELD OF THE DISCLOSURE

The present disclosure generally relates to behavioral pairing and, more particularly, to techniques for behavioral pairing in a task assignment system.

### BACKGROUND OF THE DISCLOSURE

A typical task assignment system algorithmically assigns tasks arriving at the task assignment center to agents available to handle those tasks. At times, the task assignment system may have agents available and waiting for assignment to tasks. At other times, the task assignment center may have tasks waiting in one or more queues for an agent to become available for assignment.

In some typical task assignment centers, tasks are assigned to agents ordered based on time of arrival, and agents receive tasks ordered based on the time when those agents became available. This strategy may be referred to as a “first-in, first-out,” “FIFO,” or “round-robin” strategy. For example, in an “L2” environment, multiple tasks are waiting in a queue for assignment to an agent. When an agent becomes available, the task at the head of the queue would be selected for assignment to the agent.

In some task assignment systems, a task may expire or otherwise become abandoned or inoperable if too much time passes before assigning the task to an agent. If a task assignment system uses a pairing strategy that is designed to choose among multiple possible pairings, it may be less efficient to choose a pairing without accounting for the risk of losing other tasks over time.

In view of the foregoing, it may be understood that there may be a need for a system that efficiently optimizes the application of a behavioral pairing (BP) strategy in L2 environments of a task assignment system, which accounts for the expected loss of tasks over time.

### SUMMARY OF THE DISCLOSURE

Techniques for behavioral pairing in a task assignment system are disclosed. In one particular embodiment, the techniques may be realized as a method for behavioral pairing in a task assignment system comprising: determining, by at least one computer processor communicatively coupled to and configured to operate in the task assignment system, an expected loss of each of a plurality of tasks; determining, by the at least one computer processor, an agent available for assignment to any of the plurality of tasks; and assigning, by the at least one computer processor, a task of the plurality of tasks to the agent using a task assignment strategy based on the expected outcome of the task.

In accordance with other aspects of this particular embodiment, the task assignment system may be a contact center system, and the task assignment strategy may assign contacts to contact center system agents.

In accordance with other aspects of this particular embodiment, the expected loss of each of the plurality of tasks may be determined by computing a product of a risk of abandonment of the task and an expected outcome of the task.

In accordance with other aspects of this particular embodiment, the risk of abandonment of the task may depend on a waiting time of the task.

In accordance with other aspects of this particular embodiment, the risk of abandonment of the task may be determined from a hazard function, which relates waiting times of historical tasks to risks of abandonment of the historical tasks in the task assignment system.

In accordance with other aspects of this particular embodiment, a highest priority may be given to a task of the plurality of tasks that has a highest expected loss.

In accordance with other aspects of this particular embodiment, the assigned task may be selected from a portion of tasks from a front of a queue of the plurality of tasks.

In accordance with other aspects of this particular embodiment, the task assignment strategy may be a behavioral pairing strategy.

In another particular embodiment, the techniques may be realized as a system for behavioral pairing in a task assignment system comprising at least one computer processor communicatively coupled to and configured to operate in the task assignment system, wherein the at least one computer processor is further configured to perform the steps in the above-described method.

In another particular embodiment, the techniques may be realized as an article of manufacture for behavioral pairing in a task assignment system comprising a non-transitory processor readable medium and instructions stored on the medium, wherein the instructions are configured to be readable from the medium by at least one computer processor communicatively coupled to and configured to operate in the task assignment system and thereby cause the at least one computer processor to operate so as to perform the steps in the above-described method.

The present disclosure will now be described in more detail with reference to particular embodiments thereof as shown in the accompanying drawings. While the present disclosure is described below with reference to particular embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

To facilitate a fuller understanding of the present disclosure, reference is now made to the accompanying drawings, in which like elements are referenced with like numerals. These drawings should not be construed as limiting the present disclosure, but are intended to be illustrative only.

FIG. 1 shows a block diagram of a task assignment system according to embodiments of the present disclosure.

FIG. 2 depicts a schematic representation of timeline of a risk of abandonment of a task according to embodiments of the present disclosure.

FIG. 3 shows a flow diagram of a task assignment method according to embodiments of the present disclosure.

### DETAILED DESCRIPTION

A typical task assignment system algorithmically assigns tasks arriving at the task assignment center to agents available to handle those tasks. At times, the task assignment system may have agents available and waiting for assignment to tasks. At other times, the task assignment center may have tasks waiting in one or more queues for an agent to become available for assignment.

In some typical task assignment centers, tasks are assigned to agents ordered based on time of arrival, and agents receive tasks ordered based on the time when those agents became available. This strategy may be referred to as a “first-in, first-out,” “FIFO,” or “round-robin” strategy. For example, in an “L2” environment, multiple tasks are waiting in a queue for assignment to an agent. When an agent becomes available, the task at the head of the queue would be selected for assignment to the agent.

In some task assignment systems, a task may expire or otherwise become abandoned or inoperable if too much time passes before assigning the task to an agent. If a task assignment system uses a pairing strategy that is designed to choose among multiple possible pairings, it may be less efficient to choose a pairing without accounting for the risk of losing other tasks over time.

In view of the foregoing, it may be understood that there may be a need for a system that efficiently optimizes the application of a behavioral pairing (BP) strategy in L2 environments of a task assignment system, which accounts for the expected loss of tasks over time.

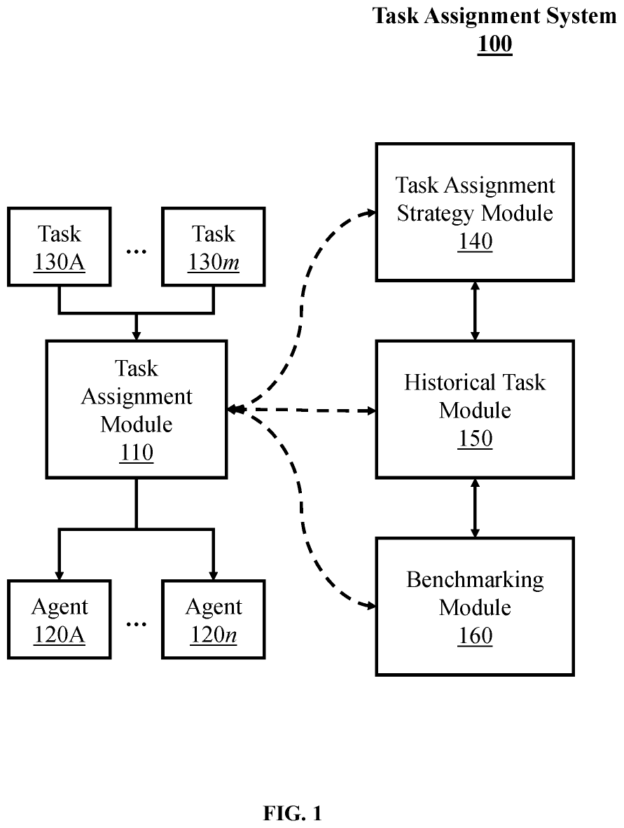

FIG. 1 shows a block diagram of a task assignment system 100 according to embodiments of the present disclosure. The description herein describes network elements, computers, and/or components of a system and method for benchmarking pairing strategies in a task assignment system that may include one or more modules. As used herein, the term “module” may be understood to refer to computing software, firmware, hardware, and/or various combinations thereof. Modules, however, are not to be interpreted as software which is not implemented on hardware, firmware, or recorded on a non-transitory processor readable recordable storage medium (i.e., modules are not software per se). It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in both devices.

As shown in FIG. 1, the task assignment system 100 may include a task assignment module 110. The task assignment system 100 may include a switch or other type of routing hardware and software for helping to assign tasks among various agents, including queuing or switching components or other Internet-, cloud-, or network-based hardware or software solutions.

The task assignment module 110 may receive incoming tasks. In the example of FIG. 1, the task assignment system 100 receives m tasks over a given period, tasks 130A-130m. Each of the m tasks may be assigned to an agent of the task assignment system 100 for servicing or other types of task processing. In the example of FIG. 1, n agents are available during the given period, agents 120A-120n. m and n may be arbitrarily large finite integers greater than or equal to one. In a real-world task assignment system, such as a contact center, there may be dozens, hundreds, etc. of agents logged into the contact center to interact with contacts during a shift, and the contact center may receive dozens, hundreds, thousands, etc. of contacts (e.g., calls) during the shift.

In some embodiments, a task assignment strategy module 140 may be communicatively coupled to and/or configured to operate in the task assignment system 100. The task assignment strategy module 140 may implement one or more task assignment strategies (or “pairing strategies”) for assigning individual tasks to individual agents (e.g., pairing contacts with contact center agents).

A variety of different task assignment strategies may be devised and implemented by the task assignment strategy module 140. In some embodiments, a first-in/first-out (“FIFO”) strategy may be implemented in which, for example, the longest-waiting agent receives the next available task (in L1 environments) or the longest-waiting task is assigned to the next available task (in L2 environments). Other FIFO and FIFO-like strategies may make assignments without relying on information specific to individual tasks or individual agents.

In other embodiments, a performance-based routing (PBR) strategy may be used for prioritizing higher-performing agents for task assignment may be implemented. Under PBR, for example, the highest-performing agent among available agents receives the next available task. Other PBR and PBR-like strategies may make assignments using information about specific agents but without necessarily relying on information about specific tasks or agents.

In yet other embodiments, a BP strategy may be used for optimally assigning tasks to agents using information about both specific tasks and specific agents. Various BP strategies may be used, such as a diagonal model BP strategy or a network flow BP strategy. These task assignment strategies and others are described in detail for the contact center context in, e.g., U.S. Pat. Nos. 9,300,802 and 9,930,180, which are hereby incorporated by reference herein.

In some embodiments, a historical task module 150 may be communicatively coupled to and/or configured to operate in the task assignment system 100 via other modules such as the task assignment module 110 and/or the task assignment strategy module 140. The historical task module 150 may be responsible for various functions such as monitoring, storing, retrieving, and/or outputting information about agent task assignments that have already been made. For example, the historical task module 150 may monitor the task assignment module 110 to collect information about task assignments in a given period. Each record of a historical task assignment may include information such as an agent identifier, a task or task type identifier, outcome information, or a pairing strategy identifier (i.e., an identifier indicating whether a task assignment was made using a BP pairing strategy or some other pairing strategy such as a FIFO or PBR pairing strategy).

In some embodiments and for some contexts, additional information may be stored. For example, in a call center context, the historical task module 150 may also store information about the time a call started, the time a call ended, the phone number dialed, and the caller's phone number. For another example, in a dispatch center (e.g., “truck roll”) context, the historical task module 150 may also store information about the time a driver (i.e., field agent) departs from the dispatch center, the route recommended, the route taken, the estimated travel time, the actual travel time, the amount of time spent at the customer site handling the customer's task, etc.

The historical task module 150 may also store information about abandoned tasks, which expired or otherwise became abandoned or inoperable prior to assignment to an agent. For example, in a call center context, a caller on hold may decide to hang up and terminate a call before it is answered by an agent. The historical task module 150 may store information about the time a call arrived, the time a call was abandoned, the caller's menu or interactive voice response (IVR) selections, the caller's phone number, etc.

In some embodiments, the historical task module 150 may generate a pairing model or similar computer processor-generate model based on a set of historical assignments or other data, such as lost task data, for a period of time (e.g., the past week, the past month, the past year, etc.), which may be used by the task assignment strategy module 140 to make task assignment recommendations or instructions to the task assignment module 110. In other embodiments, the historical task module 150 may send historical assignment information to another module such as the task assignment strategy module 140 or the benchmarking module 160.

In some embodiments, a benchmarking module 160 may be communicatively coupled to and/or configured to operate in the task assignment system 100 via other modules such as the task assignment module 110 and/or the historical task module 150. The benchmarking module 160 may benchmark the relative performance of two or more pairing strategies (e.g., FIFO, PBR, BP, etc.) using historical assignment information, which may be received from, for example, the historical task module 150. In some embodiments, the benchmarking module 160 may perform other functions, such as establishing a benchmarking schedule for cycling among various pairing strategies, tracking cohorts (e.g., base and measurement groups of historical assignments), etc. The techniques for benchmarking and other functionality performed by the benchmarking module 160 for various task assignment strategies and various contexts are described in later sections throughout the present disclosure. Benchmarking is described in detail for the contact center context in, e.g., U.S. Pat. No. 9,712,676, which is hereby incorporated by reference herein.

In some embodiments, the benchmarking module 160 may output or otherwise report or use the relative performance measurements. The relative performance measurements may be used to assess the quality of the task assignment strategy to determine, for example, whether a different task assignment strategy (or a different pairing model) should be used, or to measure the overall performance (or performance gain) that was achieved within the task assignment system 100 while it was optimized or otherwise configured to use one task assignment strategy instead of another.

In some embodiments, at the time of pairing a task with the next available agent, the BP strategy may order all the tasks in queue based on the expected loss of each task. The task with the highest expected loss is given the highest priority and placed first in queue. The BP strategy then may consider the first N tasks as in the Front-N or Head-N systems described in U.S. patent application Ser. No. 15/837,911, which is hereby incorporated by reference herein. The expected loss of each task may be determined according to the following formula:

Expected Loss=Risk of Abandonment*Expected Outcome

The expected outcome of each task, when assigned to the next available agent, may be known or estimated based on outcomes of historical assignments stored in the historical task module 150. For example, if the tasks are sales calls, each sales call may have an expected outcome, which may depend on the caller or type of caller, the item being sold, and the likelihood of the next available agent making the sale.

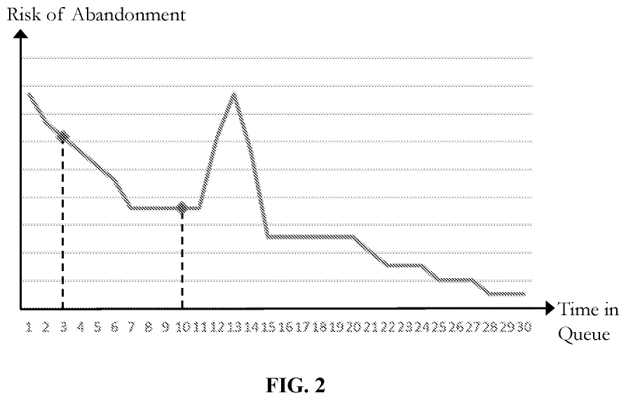

The risk of abandonment of each task (e.g., a caller hanging up and terminating a call) may depend on how long the task has been waiting in queue. Therefore, the expected loss of a task is also a function of the waiting time of the task in a queue. The risk of abandonment may be represented by a hazard (or survival) function, an example of which is illustrated in FIG. 2. In this example, the risk of losing a task during the first seconds after the task arrived is high on average. The risk begins to drop and then rises again on average around the 13th second.

In a simplified example, the BP strategy may only consider the expected loss of each task, with the hazard function shown in FIG. 2, in selecting a task to be assigned to the next available agent. If the BP strategy is to decide whether to assign a first task that has been waiting 3 seconds (when the first peak in hazard function has passed) or a second task that has been waiting 10 seconds (just before the second, higher peak), and both tasks have similar expected outcomes, the BP strategy may preferably select the second task. Even if the second task is not the longest-waiting task, it is the task with the highest risk of abandonment within the next x seconds (e.g., 5 seconds), or the task with the optimal balance of risk of abandonment and expected outcome.

Different queues in different task assignment systems may exhibit hazard functions with different characteristics. For example, some hazard functions may resemble an electrocardiogram (ECG) chart like the example depicted in FIG. 2, or a “bathtub curve,” which may show an initially decreasing risk of abandonment, followed by a relatively flat or nearly constant risk of abandonment, followed by an increasing risk of abandonment.

Hazard functions may be generated from historical information (e.g., starting times and ending times of calls, or times to abandonment) stored in the historical task module 150. The time window for the hazard function may be chosen based on a task frequency rate (e.g., calls arrive about once every five seconds).

In some embodiments, using a conversion rate analysis, the harm from lost tasks may be estimated from conversion rates of tasks based on historical data recorded by a task assignment system. For each task, an expected conversion rate may be a function of the task waiting in queue. In some environments, conversion rate may be directly correlated with waiting time. For example, in a sales queue of a contact center, a contact may be more likely to wait in queue if the contact has a strong intention to buy or order an item.

In some embodiments, the BP strategy may solve a linear programming model to determine the most efficient agent-task pairing. The linear programming may use optimization metrics, which may include an outcome matrix and the expected loss of each task. The outcome matrix may represent an expected outcome for every agent-task pair. The outcome matrix may be determined based on outcomes of historical assignments of the same or similar tasks to known agents, as stored in the historical task module 150. The expected outcome and the expected loss may be combined into a single optimization metric, for example, by adding them together. Optimizing pairings with the highest sum, weighted sum, or other combination of expected outcome and highest expected loss may allow not only optimizing the outcome, but also minimizing loss from abandoned tasks.

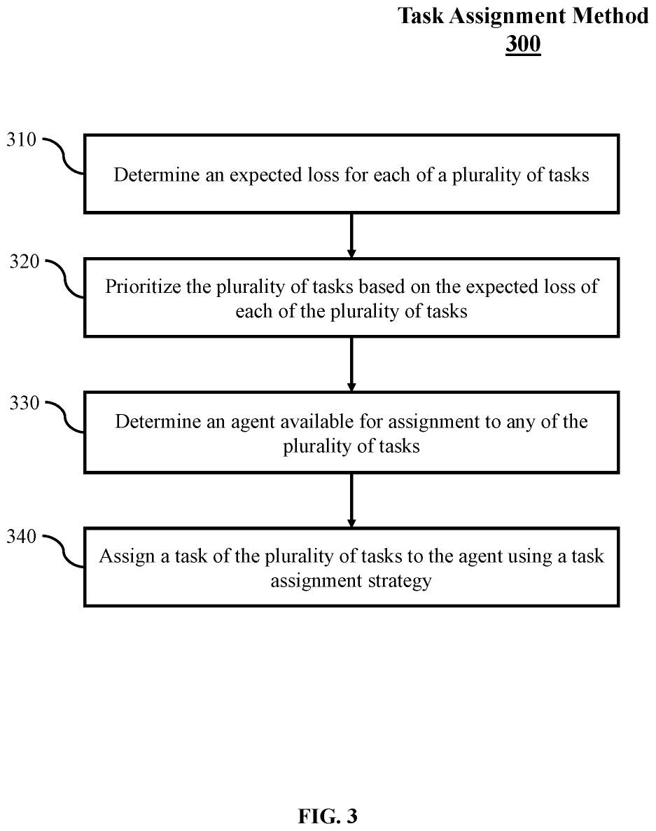

FIG. 3 shows a task assignment method 300 according to embodiments of the present disclosure.

Task assignment method 300 may begin at block 310. At block 310, an expected loss may be determined for each of a plurality of tasks in a task assignment system. The expected loss may be determined as described above.

Task assignment method 300 may then proceed to block 320. At block 320, the tasks may be prioritized based on their expected losses. In some embodiments, a task that has a highest expected loss may be given a highest priority and placed in the front of the queue. Task assignment method 300 may subsequently consider all tasks or the Front-N tasks. In other embodiments, expected loss may be one of several factors in a weighted or otherwise multidimensional pairing model.

In some embodiments, whether a service level agreement (SLA) has been exceeded for at least one task of the plurality of tasks may be determined after block 320. In some embodiments, the task assignment strategy or the task assignment system will assign an agent to a task that has exceeded its SLA (e.g., the longest-waiting task with an exceeded or blown SLA). In various embodiments, the SLA may be defined or otherwise determined according to the any of a variety of techniques, such as a fixed time, a function of EWT, or a function of the number of times a given task has been available for assignment in the Front-N. In other embodiments, there may be no SLA relevant to the task assignment strategy, and the task assignment method 300 may proceed without determining or otherwise checking for any exceeded SLAs.

Task assignment method 300 may then proceed to block 330. At block 330, an agent may be determined that is available for assignment to any of the plurality of tasks. For example, in L2 environments, an agent becomes available for assignment. In other environments, such as L3 environments, multiple agents may be available for assignment.

Task assignment method 300 may then proceed to block 340. At block 340, a task of the plurality of tasks may be assigned to the agent using the task assignment strategy. For example, if the task assignment strategy is a BP strategy, the BP strategy may consider information about each of the plurality of tasks and information about the agent to determine which task assignment is expected to optimize overall performance of the task assignment system. In some instances, the optimal assignment may be the longest-waiting, highest-priority task, as would be the case for a FIFO or PBR strategy, and/or the highest-expected-loss task. However, in other instances, the optimal assignment may be a shorter-waiting, lower-priority, and/or lower-expected-loss task. In these instances, a lower expected performance for the instant pairing may be expected to lead to a higher overall performance of the task assignment system while also, in some embodiments, achieving a balanced or otherwise targeted task utilization (e.g., normalizing or balancing average waiting time for all tasks, or balancing average waiting time for all tasks within the same priority level, or balancing expected outcome and expected loss of each task).

In some embodiments, the task assignment strategy or the task assignment system may prioritize assigning a task with an exceeded SLA (such as a longest-waiting and/or highest-priority task with an exceeded SLA) if there is one.

In some embodiments, the task assignment system may cycle among multiple task assignment strategies (e.g., cycling between a BP strategy and FIFO or a PBR strategy). In some of these embodiments, the task assignment system may benchmark the relative performance of the multiple task assignment strategies.

After assigning the task to the agent, task assignment method 300 may end.

At this point it should be noted that task assignment in accordance with the present disclosure as described above may involve the processing of input data and the generation of output data to some extent. This input data processing and output data generation may be implemented in hardware or software. For example, specific electronic components may be employed in a behavioral pairing module or similar or related circuitry for implementing the functions associated with task assignment in accordance with the present disclosure as described above. Alternatively, one or more processors operating in accordance with instructions may implement the functions associated with task assignment in accordance with the present disclosure as described above. If such is the case, it is within the scope of the present disclosure that such instructions may be stored on one or more non-transitory processor readable storage media (e.g., a magnetic disk or other storage medium), or transmitted to one or more processors via one or more signals embodied in one or more carrier waves.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of at least one particular implementation in at least one particular environment for at least one particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

1. A method for behavioral pairing in a task assignment system comprising:
calculating, by at least one computer processor communicatively coupled to and configured to perform behavioral pairing operations in the task assignment system, an expected loss of value for the task assignment system in the event of an abandoned task based on a combination of risk of abandonment and expected outcome value for the task assignment system of each of a plurality of tasks;
determining, by the at least one computer processor, an agent available for assignment to any of the plurality of tasks;
assigning, by the at least one computer processor, a task of the plurality of tasks to the agent using a task assignment strategy based on the expected loss of value for the task assignment system in the event of an abandoned task based on the combination of risk of abandonment and expected outcome value for the task assignment system of the task, wherein the task assignment strategy is determined using a task assignment strategy module communicatively coupled to and configured to operate in the task assignment system; and
establishing, in a switch of the task assignment system, a connection between the task and the agent based upon the assignment using the task assignment strategy.

2. The method of claim 1, wherein the task assignment system is a contact center system, and wherein the task assignment strategy assigns contacts to contact center system agents.

3. The method of claim 1, wherein the calculating the expected loss of value to the task assignment system comprises computing, by the at least one computer processor, a product of a risk of abandonment of the task and an expected outcome value to the task assignment system of the task.

4. The method of claim 3, wherein the risk of abandonment of the task depends on a waiting time of the task.

5. The method of claim 3, wherein the risk of abandonment of the task is determined from a hazard function, which relates waiting times of historical tasks to risks of abandonment of the historical tasks in the task assignment system.

6. The method of claim 1, wherein the task assigned during the assigning step has a highest expected loss.

7. The method of claim 1, wherein the assigning step comprises selecting the task from a portion of tasks from a front of a queue of the plurality of tasks.

8. The method of claim 1, wherein the task assignment strategy is a behavioral pairing strategy.

9. A system for behavioral pairing in a task assignment system comprising:
at least one computer processor communicatively coupled to and configured to perform behavioral pairing operations in the task assignment system, wherein the at least one computer processor is further configured to:
calculate an expected loss of value for the task assignment system in the event of an abandoned task based on a combination of risk of abandonment and expected outcome value for the task assignment system of each of a plurality of tasks;
determine an agent available for assignment to any of the plurality of tasks;
assign a task of the plurality of tasks to the agent using a task assignment strategy based on the expected loss of value for the task assignment system in the event of an abandoned task based on the combination of risk of abandonment and expected outcome value for the task assignment system of the task, wherein the task assignment strategy is determined using a task assignment strategy module communicatively coupled to and configured to operate in the task assignment system; and
establish, in a switch of the task assignment system, a connection between the task and the agent based upon the assignment using the task assignment strategy.

10. The system of claim 9, wherein the task assignment system is a contact center system, and wherein the task assignment strategy assigns contacts to contact center system agents.

11. The system of claim 9, wherein the expected loss of value to the task assignment system is calculated by computing a product of a risk of abandonment of the task and an expected outcome value to the task assignment system of the task.

12. The system of claim 11, wherein the risk of abandonment of the task depends on a waiting time of the task.

13. The system of claim 11, wherein the risk of abandonment of the task is determined from a hazard function, which relates waiting times of historical tasks to risks of abandonment of the historical tasks in the task assignment system.

14. The system of claim 9, wherein the task assigned has a highest expected loss.

15. The system of claim 9, wherein the assigned task is selected from a portion of tasks from a front of a queue of the plurality of tasks.

16. The system of claim 9, wherein the task assignment strategy is a behavioral pairing strategy.

17. An article of manufacture for behavioral pairing in a task assignment system comprising:
a non-transitory processor readable medium; and
instructions stored on the medium;
wherein the instructions are configured to be readable from the medium by at least one computer processor communicatively coupled to and configured to perform behavioral pairing operations in the task assignment system and thereby cause the at least one computer processor to operate so as to:
calculate an expected loss of value for the task assignment system in the event of an abandoned task based on a combination of risk of abandonment and expected outcome value for the task assignment system of each of a plurality of tasks;
determine an agent available for assignment to any of the plurality of tasks;
assign a task of the plurality of tasks to the agent using a task assignment strategy based on the expected loss of value for the task assignment system in the event of an abandoned task based on the combination of risk of abandonment and expected outcome value for the task assignment system of the task, wherein the task assignment strategy is determined using a task assignment strategy module communicatively coupled to and configured to operate in the task assignment system; and
establish, in a switch of the task assignment system, a connection between the task and the agent based upon the assignment using the task assignment strategy.

18. The article of manufacture of claim 17, wherein the task assignment system is a contact center system, and wherein the task assignment strategy assigns contacts to contact center system agents.

19. The article of manufacture of claim 17, wherein the expected loss of value to the task assignment system is calculated by computing a product of a risk of abandonment of the task and an expected outcome value to the task assignment system of the task.

20. The article of manufacture of claim 19, wherein the risk of abandonment of the task depends on a waiting time of the task.

21. The article of manufacture of claim 19, wherein the risk of abandonment of the task is determined from a hazard function, which relates waiting times of historical tasks to risks of abandonment of the historical tasks in the task assignment system.

22. The article of manufacture of claim 17, wherein the task assigned has a highest expected loss.

23. The article of manufacture of claim 17, wherein the assigned task is selected from a portion of tasks from a front of a queue of the prioritized plurality of tasks.

24. The article of manufacture of claim 17, wherein the task assignment strategy is a behavioral pairing strategy.
